(19) United States
(12) Patent Application Publication
(10) Pub. No.: US 2012/0285301 A1
(43) Pub. Date: Nov. 15, 2012

(54) Screwdriver Bit

(76) Inventor: Katsuyuki Totsu, Sumida-ku (JP)

(21) Appl. No.: 13/522,921

(22) PCT Filed: Dec. 20, 2010
(86) PCT No.: PCT/JP2010/072863

§ 371 Date: Jul. 18, 2012

(30) Foreign Application Priority Data
Jan. 28, 2010 (JP) 2010016636

(51) Int. Cl. B25B 15/00

(52) U.S. Cl. 81/460

(57) ABSTRACT

A screwdriver bit configured in such a way that when the tip of the screwdriver bit is to be fitted into a bit fitting groove of a screw, said bit fitting groove being formed on the top surface of the head of the screw, then damage is prevented from occurring on the top surface of the head of the screw, and proper fitting of the tip of said bit into the bit fitting groove is promptly and smoothly accomplished, with the result that the efficiency and safety of screw tightening work are significantly enhanced. This driver bit (30) is provided with a cross-shaped tip edge which is to be fitted into the bit fitting groove provided on the top surface of the head of the screw, said bit fitting groove consisting of a cross-shaped groove. In this driver bit (30), the tip surface of said tip edge (31) is formed as a whole into a spherical surface shape (34) by means of planishing.

### TECHNICAL FIELD

The present invention relates to a screwdriver bit which is configured such that in a screw fastening operation, when a tip end portion of the screwdriver bit is fitted to a bit fitting groove of a screw that is formed at a top surface of a screw head, a damage to a surrounding of the bit fitting groove at the top surface of the screw head can be prevented, fitting of the tip end portion of the bit to the bit fitting groove can be accomplished promptly and smoothly, and the efficiency and the safety of the screw fastening operation can considerably be promoted.

### BACKGROUND ART

Generally, there is widely used a plus type screwdriver bit which consists of a configuration in which a cross-shaped bit portion is provided at a tip end portion so as to be adapted to a plus thread which is formed with a bit fitting groove that consists of a cross-shaped groove at a top surface of a screw head portion. Ordinarily, according to a plus type screwdriver bit of this kind, since the bit fitting groove which is formed at the screw head portion is configured by a shape of being inscribed in an inverse circular cone shape by being directed from an opening portion that is formed in a cross-like shape to a center portion of a screw neck portion, the cross-shaped bit portion is configured in an converging shape consisting of a taper of a prescribed angle by being directed to the bit tip end portion so as to be adapted to such a shape.

According to the plus type driver bit that consists of such a configuration, a bit configuring material consists of a steel product in which chromium vanadium steel, chromium molybdenum steel or the like is rolled in a rod-like shape, and the screwdriver bit is formed by machining by using the bit configuring material.

That is, when the plus type screwdriver bit is manufactured, as shown in FIG. 7a, a bit configuring material M in a rod-like shape is pertinently held by a chuck 2 of a machine tool. While rotating the bit configuring material M around an axis center thereof, as shown in FIG. 7b, there is machined a circular cone shape protrusion 11 which consists of a taper of a prescribed angle at a front end portion of the bit configuring material M by a cutting tool 3 for cutting a taper which has a smooth cutting face.

Next, as shown in FIG. 7c, with regard to a taper face of the circular cone shape protrusion 11 which is formed at the front end portion of the bit configuring material M, by a milling cutter (rotating type tool) 5 which is mounted to a shaft portion 4 that is orthogonal to a center axis line of the bit configuring material M, there is cut a recessed portion 13 which extends in an axis line direction of the bit configuring material M, and bit portions 12 are respectively formed on both sides of the recessed portion 13. In this way, by cutting four of the recessed portions 13 which extend in the axis line direction of the bit configuring material M, the cross-shaped bit portions 12 are machined at the front end portion 11 of the bit configuring material M. Thereby, a plus type screwdriver bit 10 can be manufactured.

According to the plus type driver bit 10 of a background art which is manufactured in this way, as shown in FIGS. 8a and 8b, in a case where a screw fastening operation is carried out by applying the screwdriver bit 10 to a plus thread 20 which is provided with a bit fitting groove 23 which consists of a cross-shaped groove at a top surface 22 of a screw head portion 21 in correspondence with the driver bit 10, first, it is necessary to fit the tip end bit portion 12 of the screwdriver bit 10 to the fit configuring groove 23 of the plus thread 20 by a manual operation or the like with a required acceleration. In this case, the cross-shaped bit portion 12 of the screwdriver bit 10 is not fitted properly to the bit fitting groove 23 consisting of the cross-shaped groove of the plus thread 20 owing to a positional shift between the bit and the groove [refer to FIG. 8a] or a deviation between center axes of the bit and the thread [refer to FIG. 8b] or the like. Therefore, there is a difficulty that an edge portion of the tip end face of the cross-shaped bit portion 12 is brought into contact with an opening edge portion of the cross-shaped groove of the bit fitting groove 23 or a surrounding thereof to damage the top surface 22 of the screw head portion 21.

Also, in a case where the screwdriver bit 10 is applied to an automatic screw fastening device which is configured to carry out an automatic screw fastening operation by fitting the screwdriver bit 10 to a screw that is automatically fed by operating the screwdriver bit 10 to move forward and backward always by a constant power through a mechanical operation, as described above, a damage against the top surface 22 of the screw head portion 21 that is brought about in coupling the driver bit 10 and the screw 20 is intensified to further enhance. There is a difficulty that a proper screw fastening operation cannot be carried out.

That is, even when the proper screw fastening operation is finished for a necessary assembled product or part, the damage to the top surface 22 of the screw head portion 21 which is brought about in coupling the screwdriver bit 10 and the plus thread 20 as described above deteriorates a fine outlook in view of design in an assembled product, and effects an adverse influence on a surrounding part of an assembled part. Furthermore, in a case where the damage is significant, there is a difficulty that the proper screw fastening operation by the screwdriver bit 10 cannot be carried out.

Nevertheless, there is proposed a bit for a rotating tool which can restrain an occurrence of a comeout phenomenon without reducing a strength of a cross-shaped head portion at a tip end portion of a screwdriver bit as the plus type screwdriver bit described above (refer to Patent Document 1).

According to the bit for the rotating tool that is described in Patent Document 1, in the bit for the rotating tool which includes a cross-shaped head portion in which four sheets of blade portions which fit to a cross-shaped groove that is formed at a screw head portion are formed symmetrically, and in which inclined faces which are inclined to an axis center side as proceeding to a tip end side of the head portion are formed at outer peripheral edge portions of the respective blade portions, the bit for a rotating bit being configured such that at the inclined faces of the blade portions, plural streaks of recessed grooves having sections in a circular arc shape over width directions of the inclined faces are aligned at intervals thereamong along directions of inclinations of the inclined faces, the inclined faces remain among the recessed grooves, the recessed groove is arranged only at a portion on a front end side of the blade portion that is disposed at an inner portion of the cross-shaped groove when the cross-shaped head portion is fitted to the cross-shaped groove, and when a tip end portion of the bit is pivoted relative to the cross-shaped groove, an edge portion of each blade portion described above that is formed by the recessed groove bites the inclined face of the cross-shaped groove.

Further, there is proposed a screwdriver which is suitable for being used in an environment of assembling a precision electronic device or the like which is easily damaged by magnetism, suitable for being used in an environment of assembling a precision machine or the like which is easily damaged by rust, and light-weighted and in which fatigue of the hand and power consumption are inconsiderable (refer to Patent Document 2).

The screwdriver described in Patent Document 2 is a screwdriver which is formed with a driver tip end portion at a front end of a main body shaft portion, and which is configured such that at least the driver tip end portion is formed by titanium or a titanium alloy.

### PRIOR ART DOCUMENTS

### Patent Documents

Patent Document 1: JP 2000-167776 A

Patent Document 2: JP 2001-179643 A

### DISCLOSURE OF THE INVENTION

### Problems to be Solved by the Invention

According to the bits and the screwdrivers described in Patent Literature 1 and Patent Literature 2, there are proposed improvements of the tip end portions which are to be respectively fitted to the bit fitting grooves of the screws. However, in either thereof, it is difficult to prevent an occurrence of a damage to a top surface of a screw head portion and achieve proper fitting of the bit tip end to the bit fitting groove promptly and smoothly when the tip end portion of the screwdriver bit is fitted to the bit fitting groove of the screw.

Hence, the inventor has found that as a result of carrying out various investigations, in a screwdriver bit including a cross-shaped tip end bit portion which is to be fitted to a bit fitting groove of a screw that is provided at a top surface of a screw head portion and consists of a cross-shaped groove, by forming a tip end face of the tip end bit portion in a spherical shape totally by mirror finish, when the tip end portion of the screwdriver bit is fitted to the bit fitting groove of the screw, an occurrence of a damage to a top surface of a screw head portion can be prevented, fitting of the bit tip end portion to the bit fitting groove can promptly and smoothly be achieved, and the efficiency and the safety of a screw fastening operation can considerably be promoted.

Therefore, it is an object of the present invention to provide a screwdriver bit which is configured such that when a tip end portion of a screwdriver bit is fitted to a bit fitting groove of a screw that is formed at a top surface of a screw head portion, an occurrence of a damage to the top surface of the screw head portion can be prevented, proper fitting of the bit tip end portion to the bit fitting groove can be achieved promptly and smoothly, and the efficiency and the safety of a screw fastening operation can considerably be promoted.

### Means for Solving the Problems

In order to achieve the above-described object, a screwdriver bit according to claim 1 of the present invention is characterized in that in a screwdriver bit which includes a cross-shaped bit portion that is to be fitted to a bit fitting groove of a screw which consists of a cross-shaped groove that is provided at a top surface of a screw head portion, the screwdriver bit is configured such that a tip end face of the tip end bit potion is formed by a spherical shape totally by mirror finish.

The driver bit according to claim 2 of the present invention is characterized in being configured such that a stepped portion which forms a face that intersects with a bit axis is provided at a boundary portion of the spherical portion by the mirror finish of the tip end bit portion and the cross-shaped bit piece.

The driver bit according to claim 3 of the present invention is characterized in being configured such that a spherical face and a curved face formed by the integral mirror finish is configured from the spherical portion formed by the mirror finish of the tip end portion until a boundary portion of the cross-shaped bit piece.

### Effect of the Invention

According to the screwdriver bit described in claim 1 of the present invention, when a tip end portion of the screwdriver bit is fitted to a bit fitting groove of a screw, an occurrence of a damage to a top surface of a screw head portion can be prevented, fitting of the bit tip end portion to the bit fitting groove can be achieved promptly and smoothly, and the efficiency and the safety of a screw fastening operation can considerably be promoted. That is, by forming the tip end face of the tip end bit portion of the screwdriver bit in the spherical shape by the mirror finish, when the tip end bit portion of the screwdriver bit is fitted to the bit fitting groove of the screw with a required acceleration, in a case where the tip end face is brought into contact with the top surface of the screw head portion, even when a positional shift between the bit and groove or a deviation of center axes of the bit and the screw or the like is brought about, not only an occurrence of a significant damage to the top surface of the screw head portion can be prevented, but proper and prompt fitting of the bit tip end portion to the bit fitting groove can smoothly be guided, and an effect of contributing to the efficiency and the safety of the screw fastening operation is extremely considerable.

According to the driver bit described in Claim 2 of the present invention, the occurrence of the damage to the top surface of the screw head portion can be prevented, and the proper fitting of the bit tip end portion to the bit fitting groove can be achieved promptly and smoothly similar to the above-described. Further, particularly, by providing the stepped portion which forms a vertical face in parallel with a bit axis, “comeout” of the bit tip end portion from the bit fitting groove in a screw fastening operation can effectively be prevented.

According to the driver bit described in Claim 3 of the present invention, the occurrence of the damage to the top surface of the screw head portion can be prevented, and the proper fitting of the bit tip end portion to the bit fitting groove can promptly and smoothly be achieved similar to the above-described. Particularly, by applying the screwdriver bit to an automatic screw fastening device, the efficiency and the safety of the screw fastening operation can considerably be promoted.

### BRIEF DESCRIPTION OF THE DRAWINGS

FIG. 1 is an outline side view of a tip end bit portion showing an embodiment of a screwdriver bit according to the present invention.

FIG. 2 is an outline end face view viewing from a tip end side of the tip end bit portion of the screwdriver bit shown in FIG. 1.

FIG. 3 is an explanatory view showing a state of working to form the tip end bit portion of the screwdriver bit shown in FIG. 1, and showing a relationship between states before working and after working to form a tip end face of the tip end bit portion by mirror finish.

FIG. 4 is an outline side view of a tip end bit portion showing other example of a screwdriver bit according to the present invention.

FIG. 5 is an outline end face view viewing from a tip end side of a tip end bit portion of the screwdriver bit shown in FIG. 4.

FIG. 6 is an explanatory view showing a state of working to form the tip end bit portion of the driver bit shown in FIG. 4, and showing a relationship between states before working and after working to form a tip end face of the tip end bit portion by mirror finish.

FIGS. 7a through 7c are outline explanatory views respectively showing steps of working to form a tip end bit portion of a screwdriver bit of a background art.

FIGS. 8a and 8b are outline explanatory views of the tip end bit portion relative to a screw head portion respectively showing improper fitting states in a case of fitting the tip end bit portion of the plus type driver bit of the background art to a bit fitting groove of a plus thread.

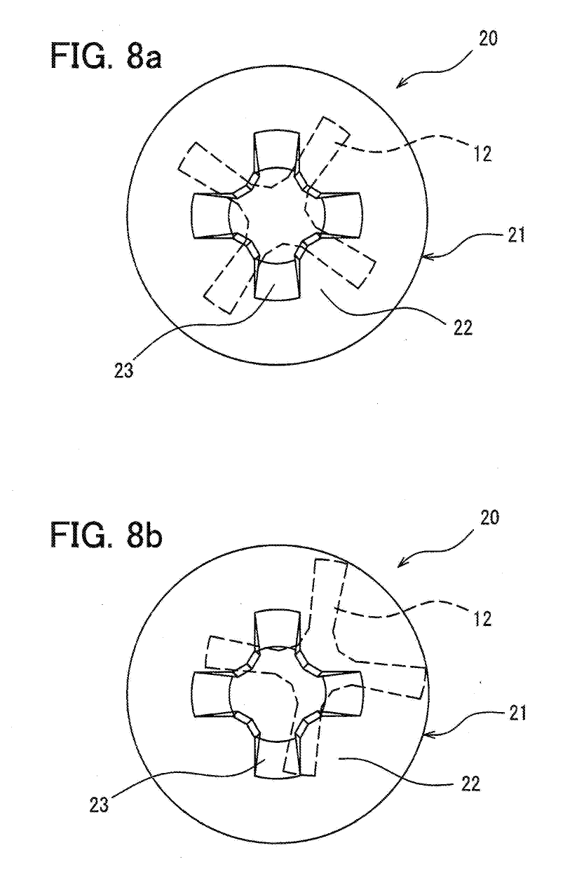

### BEST MODES FOR CARRYING OUT THE INVENTION

Next, a detailed explanation will be given as follows of examples of a screw driver bit according to the present invention in reference to the attached drawings.

### Example 1

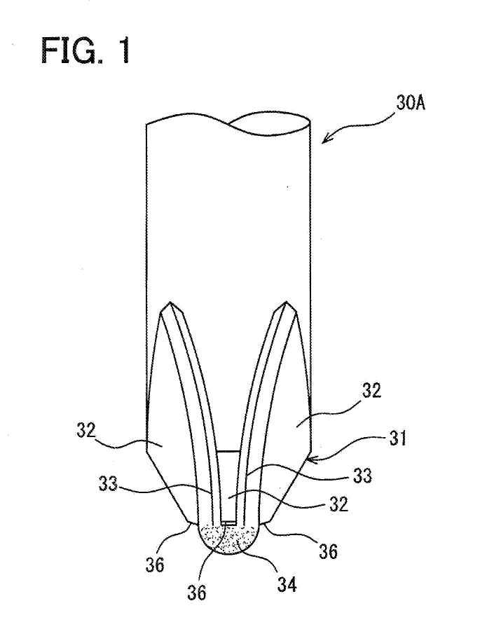

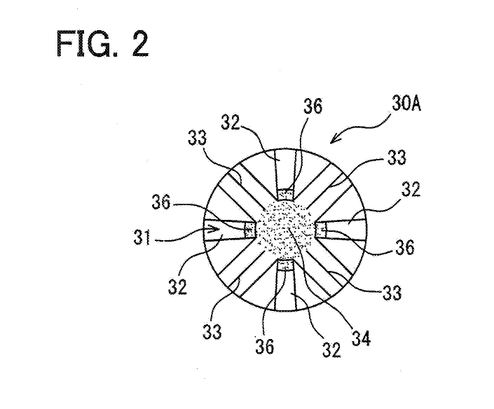

FIG. 1 and FIG. 2 show an example of a screwdriver bit according to the present invention, FIG. 1 is an outline side view of a tip end bit portion, and FIG. 2 is an outline end face view of a tip end face of the tip end bit portion. In FIG. 1 and FIG. 2, reference sign 30A designates a plus type screwdriver bit which includes a tip end bit portion 31 which is provided with a cross-shaped bit piece 32 that is fitted to a bit fitting groove of a screw consisting of a cross-shaped groove that is formed at a top surface of a screw head portion and which is protruded in a circular cone shape.

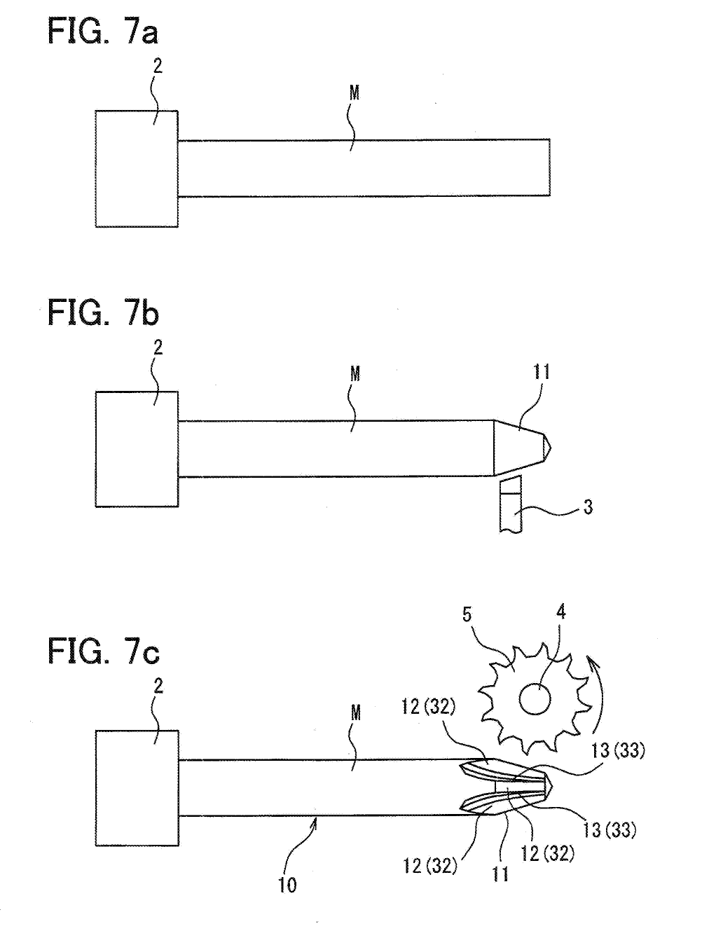

Nevertheless, the plus type driver bit 30A of the example that is configured in this way can be formed similar to the plus type driver bit 10 of the background art as shown in FIGS. 7a through 7c. That is, basically, the bit configuring material M in the rod-like shape is pertinently held by the chuck 2 of the machine tool [refer to FIG. 7a], and while rotating the bit configuring material M around the axis center, by the working tool 3 for cutting a taper that includes a smooth cutting face, the protruded portion in the circular cone shape which consists of a taper of a prescribed angle is machined at the front end of the bit configuring material M [refer to FIG. 7b].

Next, with regard to a taper face of the protruded portion in the circular cone shape which is formed at the tip end portion of the bit configuring material M, by the milling cutter (rotating type tool) 5 which is mounted to the shaft portion 4 that is orthogonal to the center axis line of the bit configuring material M, a recessed portion 33 which is extended in the axis line direction of the bit configuring material M is cut, and bit pieces 32 are respectively formed on both sides of the recessed portion [refer to FIG. 7c]. In this way, by cutting four of the recessed portions 33 which are extended in the axis line direction of the bit configuring material M, the cross-shaped bit pieces 32 are machined at the front end portion of the bit configuring material M. Thereby, the plus type screwdriver bit 30A can be manufactured.

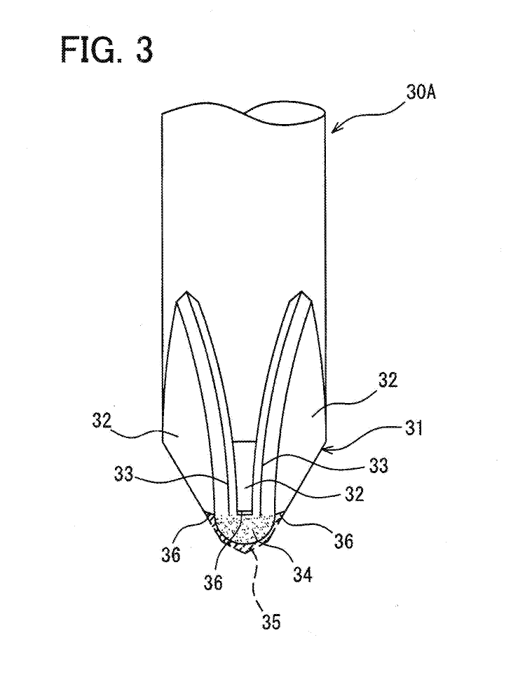

Hence, according to the screwdriver bit 30A of the example, as shown in FIG. 3, with regard to the tip end bit portion 31 of the plus type screwdriver bit 30A which is manufactured as described above, a tip end face thereof is formed in a spherical shape (dotted display portion) totally by mirror finish. That is, as shown in FIG. 3, with regard to a tip end portion (broken line and hatching display portion) 35 which is formed in a shape of a circular cone protrusion of the tip end bit portion 31 of the plus type driver bit 30A, mirror finish is carried out by using a diamond tool (not illustrated) or the like. Thereby, there consists a configuration in which by polishing to remove the tip end portion 35, a portion 34 in a spherical shape is configured by the mirror finish, and at a boundary portion of the spherical shape portion 34 and the cross-shaped bit piece 32, a stepped portion 36 (dotted display portion) which forms a face that intersects with a bit axis is provided.

According to the driver bit 30A of the present embodiment which consists of such a configuration, as shown in FIG. 1 and FIG. 2, by providing the spherical face portion 34 (dotted display portion) formed by the mirror finish and the stepped portion 36 (dotted display portion) at the tip end face of the tip end bit portion 31, in a case where the tip end bit portion 31 of the screwdriver bit 30A is brought into contact with a top face of a screw head portion so as to be fitted to a bit fitting groove of a screw with a required acceleration, even when there is not a coincidence therebetween by the positional shift of the bit and the groove or the deviation of the center axes of the bit and the screw or the like, an occurrence of a significant damage to the top surface of the screw head portion can be prevented, the proper and prompt fitting of the bit tip end portion to the bit fitting groove can smoothly be guided, and the efficiency and the safety of the screw fastening operation can considerably be promoted.

### Example 2

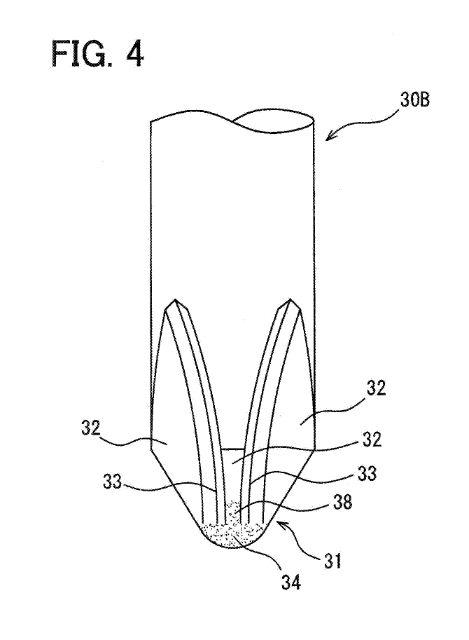

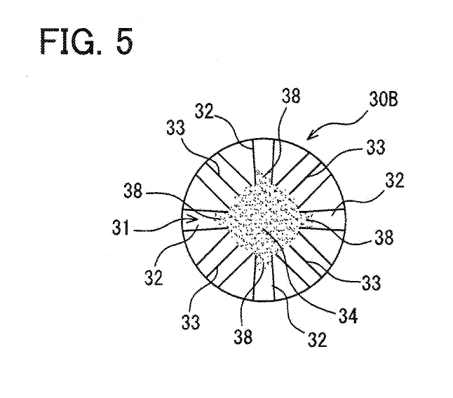

FIG. 4 and FIG. 5 show other embodiment of a screwdriver bit according to the present invention, FIG. 4 is an outline side view of a tip end bit portion, and FIG. 5 is an outline plan view of a tip end face of the tip end bit portion. Incidentally, for convenience of explanation, an explanation will be given by attaching the same reference sign to a constituent element the same as that of Example 1 shown in FIG. 1 through FIG. 3. Therefore, in FIG. 4 and FIG. 5, reference sign 30B designates a plus type screwdriver bit which includes the tip end bit portion 31 which is provided with the cross-shaped bit piece 32 that is fitted to a bit fitting groove of a screw consisting of a cross-shaped groove that is formed at a top surface of a screw head portion and which is protruded in a circular cone shape.

Nevertheless, also in the plus type driver bit 30B of the present example, quite similar to Example 1 described above, as shown in FIGS. 7a through 7c, the plus type driver bit 30B which is formed, basically, with the cross-shaped bit piece 32 at a front end portion of the bit configuring material M, can be manufactured by machining similar to that of the plus type driver bit 10 of the background art.

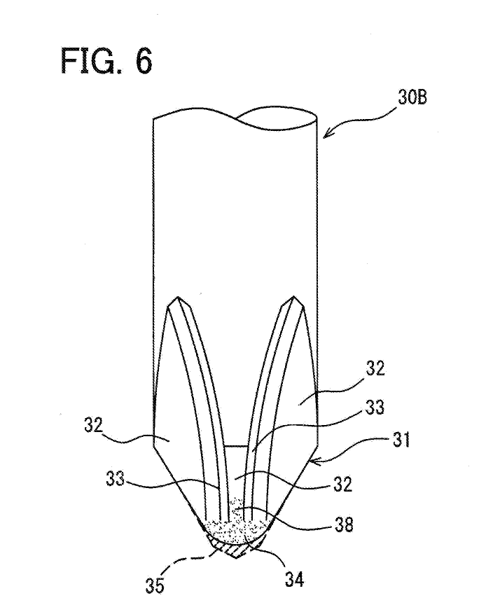

Hence, according to the screwdriver bit 30B of the present example, as shown in FIG. 6, with regard to the tip end bit portion 31 of the plus type driver bit 30B which is manufactured as described above, a tip end face thereof is formed in a spherical shape (dotted display portion) totally by mirror finish. That is, as shown in FIG. 6, mirror finish is carried out by using a diamond tool (not illustrated) or the like for the tip end portion (broken line and hatching display portion) 35 which is formed in the shape of the circular cone protrusion of the tip end bit portion 31 of the plus type driver bit 30B. Thereby, there consists a configuration in which the spherical portion 34 is configured by mirror finish by polishing to remove the tip end portion 35, and a curved face 38 (dotted display portion) is also configured by integral mirror finish which reaches a boundary portion of the spherical portion 34 and the cross-shaped bit piece 32 from the spherical portion 34.

According to the driver bit 30B of the present embodiment which is configured in this way, as shown in FIG. 4 and FIG. 5, by providing the spherical portion 34 (dotted display portion) and the curved face 38 (dotted display portion) by mirror finish at the tip end face of the tip end bit portion 31, quite similar to Example 1 described above, an occurrence of a significant damage to the top surface of the screw head portion can be prevented, the proper and prompt fitting of the bit tip end portion to the bit fitting groove can smoothly be guided. Particularly, the present embodiment is effective in being applied to an automatic screw fastening device, and an effect of contributing to the efficiency and the safety of the screw fastening operation is extremely considerable.

Although an explanation has been given of preferable embodiments of the present invention as described above, the present invention is not limited to the examples described above but can be applied also to a screwdriver bit which has a tip end bit portion that adapts to screws having various kinds of bit fitting grooves which consist of shapes other than that of the cross-shaped groove. Moreover, a number of design changes can also be carried out within a range not deviated from the spirit of the present invention.

### DESCRIPTION OF THE REFERENCE SYMBOLS

30A, 30B: plus type screwdriver bits
31: tip end bit portion
32: cross-shaped bit piece
33: recessed portion
34: spherical shape portion
35: polish to remove portion
36: stepped portion
38: curved face

1. A screwdriver bit comprising a cross-shaped tip end bit portion fitted to a bit fitting groove of a screw including a cross-shaped groove provided at a top surface of a screw head portion, wherein
the screwdriver bit is configured such that a tip end face of said tip end bit potion is formed in a spherical shape totally by a mirror finish.

2. The screwdriver bit according to claim 1, wherein
the screwdriver bit is configured such that a stepped portion forming a face intersecting with a bit axis is provided at a boundary portion of a portion of the spherical shape formed by the mirror finish of said tip end bit portion and a cross-shaped bit piece.

3. The screwdriver bit according to claim 1, wherein
the screwdriver bit is configured such that a spherical face and a curved face are formed by an integral mirror finish from a portion of spherical shape formed by the mirror finish of said tip end bit portion until a boundary portion of a cross-shaped bit piece.
